(19) United States
(12) Patent Application Publication
(10) Pub. No.: US 2022/0172287 A1
(43) Pub. Date: Jun. 2, 2022

(54) METHOD AND DEVICE FOR PROCESSING LOAN SECURED BY DIGITAL ASSETS

(71) Applicant: DELIO CORP., Gyeonggi-do (KR)

(72) Inventor: Sang Ho JUNG, Seoul (KR)

(21) Appl. No.: 17/672,665

(22) Filed: Feb. 15, 2022

Related U.S. Application Data
(63) Continuation of application No. PCT/KR2020/010923, filed on Aug. 14, 2020.

(51) Int. Cl. G06Q 40/02; G06Q 20/36

(52) U.S. Cl. CPC G06Q 40/025; G06Q 2220/00; G06Q 20/3676; G06Q 20/3678

(57) ABSTRACT

The present invention relates to a method and device for processing a loan secured by digital assets such as cryptocurrency. Particularly, the present invention relates to a method and device for processing a loan of an amount in a second currency type secured by an amount in a first currency type stored in a cryptocurrency wallet and the like in a cryptocurrency exchange. The present invention can provide a method and device which can minimize the risk of principal loss, by means of a principal withdrawal secured by a cryptocurrency balance in a wallet generated in a cryptocurrency exchange, and conveniently and quickly process a collateral loan by lending additional cryptocurrency with respect to a predetermined rate of an amount of cryptocurrency owned by a user.

### CROSS-REFERENCE TO RELATED APPLICATION

This application is a US Bypass Continuation Application of International Application No. PCT/KR2020/010923, filed on Aug. 14, 2020, the disclosure of which is incorporated herein by reference in its entirety.

### BACKGROUND

### Technical Field

The present invention relates to a method and device for processing a loan secured by digital assets such as cryptocurrency. Specifically, the present invention relates to a method and device for processing a loan in a second currency type using an amount of a first currency type kept in a cryptocurrency wallet and the like in a cryptocurrency exchange as collateral.

### Background Art

In modern society, the loan business of financial institutions, such as banks and credit companies, occupies an important part. The loan business is a business that generates a certain amount of economic power in the borrower using the borrower's specific property or credit as collateral. Above all, risk avoidance is the most important matter, and from the borrower's point of view, it is important to promptly handle the loan business of financial institutions.

However, in the case of a normal loan, financial institutions manage the amount paid by a lender and lend it to a borrower, and thus the risk of not being able to recover the loan is mostly borne by the financial institutions. Therefore, to avoid this risk even a little bit more, financial institutions make the difference between an interest received from the borrower and an interest paid to the lender even slightly larger. Consequently, there is a problem in that the borrower should pay a higher interest than necessary, and the lender has no choice but to earn a lower interest income than possible.

Meanwhile, unlike these existing financial loans, peer-to-peer (P2P) lending is a method of recruiting investors, directly mediating between the investors and borrowers who need funds so that the borrowers can borrow funds in the form of investment, and receiving a small amount of commission. When an investor invests by setting a certain investment condition, for example, an investment period, the P2P lending method involves the problem that recovery of the investment principal is possible only after the investment period elapses because a direct bond/debt relationship exists between the investor and a borrower due to the nature of the P2P lending method that simply performs investment brokerage. In other words, when the investor has to recover the investment before the investment period for various reasons, there is a problem in that it is impossible to recover the investment because the payment of the bond cannot be forced before the investment period set as the period of payment. In this case, even though the investor is a creditor, the investor may go into bankruptcy according to the investor's situation because the investor cannot repay his or her own debt.

Various embodiments of the present invention solve the above-described problems by providing a method and device for processing a loan secured by digital assets such as cryptocurrency.

### SUMMARY

### Technical Problem

The present invention is directed to providing a method and device for processing a secured loan which minimize a lender's risk of principal loss and are convenient and fast for a borrower on the basis of a method of lending additional cryptocurrency secured by a cryptocurrency balance in a wallet generated in a cryptocurrency exchange.

The present invention is also directed to providing a method and device for processing a loan with a minimized risk of principal loss by applying different collateral rates and recovery rates depending on the exchange and currency type.

The present invention is also directed to providing a method and device for processing a loan with a minimized risk of principal loss by performing a lock procedure for the address of a cryptocurrency wallet which is collateral.

The present invention is also directed to providing a method and device for processing a loan with a minimized risk of malfunction in a loan process by performing a process of loan through separate servers.

The present invention is also directed to providing a method and device for processing a loan with a minimized risk of principal loss by making a withdrawal on collateral when a recovery rate, which is determined differently depending on the exchange and currency type, is reached after a loan is provided.

The present invention is also directed to providing a method and device for efficiently and conveniently processing a loan by processing the loan secured by a balance in a plurality of cryptocurrency wallets in a plurality of cryptocurrency exchanges through communication with one terminal of one user.

Objects of the present invention are not limited to those described above, and other objects which have not described above will be clearly understood by those of ordinary skill in the art from the following descriptions.

### Technical Solution

One aspect of the present invention provides a method of operating a loan system including one or more loan-related servers. Each of the one or more loan-related servers includes a memory, at least one processor, and a transceiver. The method includes: receiving, from one or more cryptocurrency exchange servers or a terminal of a user, a loan request message including identification information of the user, balance information about a cryptocurrency balance in at least one first currency type in one or more cryptocurrency wallets in one or more cryptocurrency exchanges of the user, a security, which is smaller than or equal to the cryptocurrency balance, in the first currency type, and loan information about a requested loan amount in a second currency type; checking the cryptocurrency balance of the one or more cryptocurrency wallets in the one or more cryptocurrency exchanges of the user from the one or more cryptocurrency exchange servers on the basis of the identification information and the balance information; performing a lock procedure for addresses of the one or more cryptocurrency wallets; receiving, from the one or more cryptocurrency exchange servers, a trading volume of the at least one first currency type in the one or more cryptocurrency exchanges, a total holding of the at least one first currency type in the one or more cryptocurrency exchanges, market capitalization of the at least one first currency type, and exchange currency information about a transaction share of the at least one first currency type in the one or more cryptocurrency exchanges; determining an exchange grade for each of the one or more cryptocurrency exchanges and a currency grade for each of the at least one first currency type on the basis of the exchange currency information, wherein the exchange grade is determined to be higher when the trading volume of the at least one first currency type in the one or more cryptocurrency exchanges, the total holding of the at least one first currency type in the one or more cryptocurrency exchanges, and the transaction share of the at least one first currency type in the one or more cryptocurrency exchanges are higher, and the currency grade is determined to be higher when the trading volume of the at least one first currency type in the one or more cryptocurrency exchanges and the market capitalization of the at least one first currency type are higher; determining a collateral rate and a recovery rate differently for each of the one or more cryptocurrency exchanges on the basis of the exchange grade and the currency grade wherein the collateral rate is a value between 0% and 100% as a ratio of a pre-loan cash value of the requested loan amount in the second currency type to a pre-loan cash value of the security in the at least one first currency type, the recovery rate is a value between the collateral rate and 100% as a ratio of a post-loan cash value of the requested loan amount in the second currency type to a post-loan cash value of the security, which is collateral of the loan, in the at least one first currency type, and the collateral rate and the recovery rate are determined to be higher when the exchange grade and the currency grade are higher; determining approval of the loan on the basis of the balance information about the one or more cryptocurrency wallets and the collateral rate in the one or more cryptocurrency exchanges of the user when a loanable amount of the second currency type is greater than or equal to the requested loan amount in the second currency type wherein the loanable amount is an amount of the second currency type corresponding to a cash value of a product of the security in the at least one first currency type and the collateral rate; when the approval of the loan is determined, transferring the requested loan amount in the second currency type from a cryptocurrency loan wallet of the loan system to a set loan cryptocurrency wallet of the user to provide the loan; periodically monitoring market prices of the first currency type and the second currency type from the one or more cryptocurrency exchange servers after providing the loan, and determining a ratio of the cash value of the requested loan amount in the second currency type to the cash value of the security in the at least one first currency type; when the ratio of the post-loan cash value of the requested loan amount in the second currency type to the post-loan cash value of the security in the at least one first currency type reaches the recovery rate, checking the security in the one or more locked cryptocurrency wallets in the one or more cryptocurrency exchanges of the user from the one or more cryptocurrency exchange servers; withdrawing an amount of the at least one first currency type corresponding to the cash value of the requested loan amount in the second currency type from the security in the at least one first currency type in the one or more cryptocurrency wallets in the one or more cryptocurrency exchanges; and performing an unlock procedure for the addresses of the one or more cryptocurrency wallets.

### Advantageous Effects

The present invention can provide a method and device for minimizing the risk of principal loss through a principal recovery method secured by the cryptocurrency balance of a wallet generated in a cryptocurrency exchange and processing a convenient and fast loan through a method of loaning additional cryptocurrency with respect to a certain ratio of the amount of cryptocurrency held by a user.

The present invention can provide a method a device for processing a loan with a minimized risk of principal loss by applying different collateral rates and recovery rates depending on the exchange and currency type.

The present invention can provide a method a device for processing a loan with a minimized risk of principal loss by performing a lock procedure for the address of a cryptocurrency wallet which is collateral.

The present invention can provide a method a device for processing a loan with a minimized risk of malfunction in a loan process by performing each process of loan through a separate server.

The present invention can provide a method a device for processing a loan with a minimized risk of principal loss by making a withdrawal from a security when a recovery rate determined differently depending on the exchange and currency type is reached after the loan is provided.

The present invention can provide a method a device for processing a loan efficiently and conveniently by processing the loan secured by a balance of a plurality of cryptocurrency wallets in a plurality of cryptocurrency exchanges through communication with one terminal of one user.

Effects of the present invention are not limited to those described above, and other effects which have not been described can be clearly understood by those of ordinary skill in the art from the following descriptions.

### BRIEF DESCRIPTION OF THE DRAWINGS

FIG. 1 is a diagram illustrating a communication system according to various embodiments of the present invention.

FIG. 2 is a block diagram illustrating a configuration of a loan system according to various embodiments of the present invention.

FIG. 3 is a signal sequence diagram illustrating a method of processing a loan secured by digital assets according to various embodiments of the present invention.

FIG. 4 is a flowchart illustrating an operating process of a loan system according to various embodiments of the present invention.

FIG. 5 illustrates an overview of a loan system according to various embodiments of the present invention.

FIG. 6 illustrates a process of a loan system according to various embodiments of the present invention.

FIG. 7 illustrates a process performed by each entity in a loan system according to various embodiments of the present invention.

FIG. 8 illustrates effects of a loan system according to various embodiments of the present invention.

FIG. 9 illustrates a process of a loan system according to various embodiments of the present invention.

FIG. 10 illustrates a loan payment process according to various embodiments of the present invention.

FIG. 11 illustrates a security liquidation process according to various embodiments of the present invention.

FIG. 12 illustrates an overview of a loan system secured by assets of a plurality of cryptocurrency wallets in a plurality of cryptocurrency exchanges according to various embodiments of the present invention.

### DETAILED DESCRIPTION

### Modes of the Invention

Hereinafter, embodiments of the present invention will be described with reference to the accompanying drawings so that those of ordinary skill in the art can easily implement the present invention. The present invention can be implemented in various forms and is not limited to embodiments described herein.

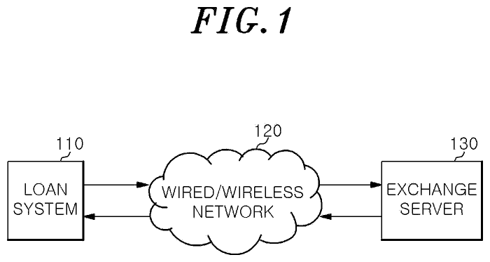

FIG. 1 is a diagram illustrating a communication system according to various embodiments of the present invention.

Referring to FIG. 1, the communication system according to various embodiments of the present invention includes a loan system 110, a wired/wireless communication network 120, and an exchange server 130.

The loan system 110 is a system including one or more loan-related servers that may acquire information on the cryptocurrency balance of a user, information on a trading volume of a specific currency type in an exchange, etc. from the exchange server 130 through the wired/wireless communication network 120 and transmit messages about locking of a security, provision of a loan, a withdrawal of the security, etc. to the exchange server 130. Each loan-related server constituting the loan system 110 may be an electronic device including a memory for storing information, a transceiver unit for transmitting and receiving information, and at least one processor for computing information.

The wired/wireless communication network 120 provides a communication path through which the loan system 110 and the exchange server 130 may transmit and receive signals and data to and from each other. The wired/wireless communication network 120 is not limited to a communication method based on a specific communication protocol, and an appropriate communication method for an implementation example may be used. For example, when the communication system is configured on the basis of the Internet protocol (IP), the wired/wireless communication network 120 may be implemented as a wired and wireless Internet network, and when the loan system 110 and the exchange server 130 are implemented as mobile communication terminals, the wired/wireless communication network 120 may be implemented as a wireless network such as a cellular network or a wireless local area network (WLAN).

The exchange server 130 is a terminal device that may transmit the information on the cryptocurrency balance of the user, the information on the trading volume of the specific currency type, etc. to the loan system 110 through the wired/wireless communication network 120 and receive messages about locking of the security, provision of the loan, the withdrawal of the security, etc. from the electronic device 110. The server 130 may be an electronic device including a memory for storing information, a transceiver unit for transmitting and receiving information, and at least one processor for computing information.

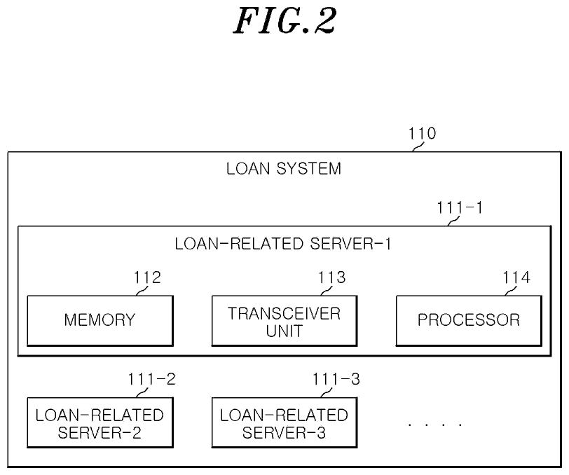

FIG. 2 is a block diagram illustrating a configuration of a loan system according to various embodiments of the present invention.

Referring to FIG. 2, the loan system 110 includes a plurality of loan-related servers 111-1, 111-2, 111-3, . . . .

Each of the loan-related servers 111-1, 111-2, and 111-3 constituting the loan system 110 means a server managed by a company that processes or brokers a loan secured by digital assets. The exchange server 130 may process a loan secured by digital assets through interoperation with each of the loan-related servers 111-1, 111-2, and 111-3 constituting the loan system 110.

The memory 112 may be connected to the transceiver unit 113 and store information and the like received through communication. Also, the memory 112 may store data including a basic program, an application program, and setting information for operations of the processor 114, information generated by computation of the processor 114, etc. The memory 112 may be configured with a volatile memory, a non-volatile memory, or a combination of a volatile memory and a non-volatile memory. Also, the memory 112 may provide the stored data according to a request from the processor 114.

The transceiver unit 113 is connected to the processor 114 and transmits and/or receives a signal. All or a part of the transceiver unit 113 may be referred to as a transmitter, a receiver, or a transceiver. The transceiver unit 113 may support at least one of various wireless communication standards including an Institute of Electrical and Electronics Engineers (IEEE) 802.xx system, an IEEE Wi-Fi system, a Third Generation Partnership Project (3GPP) system, a 3GPP Long Term Evolution (LTE) system, a 3GPP Fifth Generation (5G) new radio (NR) system, a Third Generation Partnership Project 2 (3GPP2) system, Bluetooth, etc. which are wired access systems and wireless access systems.

The processor 114 may be configured to implement a procedure and/or methods proposed by the present invention. The processor 114 controls overall operations of the loan-related server 111-1 constituting the loan system 110. For example, the processor 114 transmits or receives information and the like through the transceiver unit 113. Also, the processor 114 records and reads data in or from the memory 112. The processor 114 may include at least one processor.

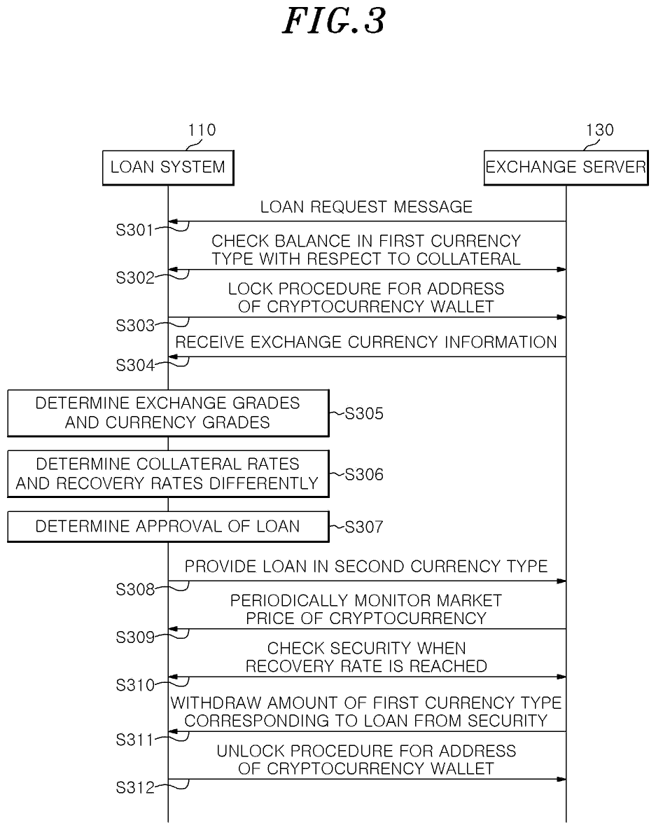

FIG. 3 is a signal sequence diagram illustrating a method of processing a loan secured by digital assets according to various embodiments of the present invention.

Referring to FIG. 3, in an operation S301, the loan system 110 receives a loan request message including identification information of a user, balance information about a cryptocurrency balance in at least one first currency type in one or more cryptocurrency wallets in one or more cryptocurrency exchanges of the user, a security in the first currency type, and loan information about a requested loan amount in a second currency type from one or more cryptocurrency servers 130 or a terminal of the user. According to an embodiment, the cryptocurrency balance is greater than or equal to the security.

In an operation S302, the loan system 110 checks the cryptocurrency balance of the one or more cryptocurrency wallets in the one or more cryptocurrency exchanges of the user from the one or more cryptocurrency exchange servers 130 on the basis of the identification information and the balance information.

In an operation S303, the loan system 110 performs a lock procedure for the addresses of the one or more cryptocurrency wallets.

In an operation S304, from the one or more cryptocurrency exchange servers 130, the loan system 110 receives a trading volume of the at least one first currency type in the one or more cryptocurrency exchanges, a total holding of the at least one first currency type in the one or more cryptocurrency exchanges, market capitalization of the at least one first currency type, and exchange currency information about a transaction share of the at least one first currency type in the one or more cryptocurrency exchanges.

In an operation S305, the loan system 110 determines an exchange grade for each of the one or more cryptocurrency exchanges and a currency grade for each of the at least one first currency type on the basis of the exchange currency information. According to an embodiment, the exchange grade is determined to be higher when the trading volume of the at least one first currency type in the one or more cryptocurrency exchanges, the total holding of the at least one first currency type in the one or more cryptocurrency exchanges, and the transaction share of the at least one first currency type in the one or more cryptocurrency exchanges are higher. According to an embodiment, the currency grade is determined to be higher when the trading volume of the at least one first currency type in the one or more cryptocurrency exchanges and the market capitalization of the at least one first currency type are higher.

In an operation S306, the loan system 110 determines a collateral rate and a recovery rate differently for each of the one or more cryptocurrency exchanges on the basis of the exchange grade and the currency grade. According to an embodiment, the collateral rate is a value between 0% and 100% as a ratio of a pre-loan cash value of the requested loan amount in the second currency type to a pre-loan cash value of the security in the at least one first currency type. According to an embodiment, the recovery rate is a value between the collateral rate and 100% as a ratio of a post-loan cash value of the requested loan amount in the second currency type to a post-loan cash value of the security, which is collateral of the loan, in the at least one first currency type. According to an embodiment, the collateral rate and the recovery rate are determined to be higher when the exchange grade and the currency grade are higher.

In an operation S307, the loan system 110 determines approval of the loan on the basis of the balance information about the one or more cryptocurrency wallets and the collateral rate in the one or more cryptocurrency exchanges of the user when a loanable amount of the second currency type is greater than or equal to the requested loan amount in the second currency type. According to an embodiment, the loanable amount is an amount of the second currency type corresponding to a cash value of a product of the security in the at least one first currency type and the collateral rate.

In an operation S308, when the approval of the loan is determined, the loan system 110 provides the loan by transferring the requested loan amount in the second currency type from a cryptocurrency loan wallet of the loan system to a set loan cryptocurrency wallet of the user.

In an operation S309, after providing the loan, the loan system 110 periodically monitors market prices of the first currency type and the second currency type from the one or more cryptocurrency exchange servers 130. Also, the loan system 110 determines a ratio of the cash value of the requested loan amount in the second currency type to the cash value of the security in the at least one first currency type.

In an operation S310, when the ratio of the post-loan cash value of the requested loan amount in the second currency type to the post-loan cash value of the security in the at least one first currency type reaches the recovery rate, the loan system 110 checks the security in the one or more locked cryptocurrency wallets in the one or more cryptocurrency exchanges of the user from the one or more cryptocurrency exchange servers 130.

In an operation S311, the loan system 110 withdraws an amount of the at least one first currency type corresponding to the cash value of the requested loan amount in the second currency type from the security in the at least one first currency type in the one or more cryptocurrency wallets in the one or more cryptocurrency exchanges.

In an operation S312, the loan system 110 performs an unlock procedure for the addresses of the one or more cryptocurrency wallets.

According to an embodiment, the loan system 110 may include an application server, an approval server, and a loan server. According to an embodiment, the operation of receiving the loan request message, the operation of checking the cryptocurrency balance, and the operation of performing a lock procedure for the security in the cryptocurrency balance may be performed by the application server. According to an embodiment, the operation of receiving the exchange information, the operation of determining an exchange grade and a currency grade, the operation of determining the collateral rate and the recovery rate, and the operation of determining approval of the loan may be performed by the approval server. According to an embodiment, the operation of providing the loan may be performed by the loan server. According to an embodiment, the application server, the approval server, and the loan server may be connected to each other electrically or via a communication network.

According to an embodiment, the loan system 110 may include a price server, a liquidation confirmation server, a liquidation withdrawal server, and an unlock server. According to an embodiment, the operation of monitoring the market prices of the first currency type and the second currency type and determining the ratio of the cash value of the requested loan amount to the cash value of the security may be performed by the price server. According to an embodiment, the operation of checking the security in the one or more locked cryptocurrency wallets in the one or more cryptocurrency exchanges of the user from the one or more cryptocurrency exchange servers 130 may be performed by the liquidation confirmation server. According to an embodiment, the operation of withdrawing the amount of first currency corresponding to the cash value of the requested loan amount in the security from the one or more cryptocurrency wallets in the one or more cryptocurrency exchanges may be performed by the liquidation withdrawal server. According to an embodiment, the operation of performing the unlock procedure for the one or more cryptocurrency wallets may be performed by the unlock server. According to an embodiment, the price server, the liquidation confirmation server, the liquidation withdrawal server, and the unlock server may be connected to each other electrically or via a communication network.

According to an embodiment, after providing the loan, the loan system 110 may withdraw an amount corresponding to an interest rate, which is set for an amount corresponding to the cash value of the requested loan amount in the second currency type at the time point of providing the loan, from the one or more cryptocurrency wallets in the one or more cryptocurrency exchanges of the user or the set loan cryptocurrency wallet of the user every set period of time.

According to an embodiment, when an error occurs in operations of the price server, the liquidation confirmation server, the liquidation withdrawal server, and the unlock server, the operations may be manually processed.

According to an embodiment, to perform the lock procedure for the addresses of the one or more cryptocurrency wallets, the loan system 110 may transmit a lock request message including the identification information of the user, approval information for the loan request message, and lock request information for the addresses of the one or more cryptocurrency wallets in the one or more cryptocurrency exchanges to the one or more cryptocurrency exchange servers 130 and receive a lock completion message including lock completion information for the addresses of the one or more cryptocurrency wallets from the one or more cryptocurrency exchange servers 130.

According to an embodiment, to perform the unlock procedure for the addresses of the one or more cryptocurrency wallets, the loan system 110 may transmit a unlock request message including the identification information of the user, approval information for the loan request message, and unlock request information for the addresses of the one or more cryptocurrency wallets in the one or more cryptocurrency exchanges to the one or more cryptocurrency exchange servers 130 and receive a unlock completion message including unlock completion information for the addresses of the one or more cryptocurrency wallets from the one or more cryptocurrency exchange servers 130.

According to an embodiment, the set loan cryptocurrency wallet may include at least one of a cryptocurrency wallet of the user in the one or more cryptocurrency exchange servers, a cryptocurrency custody of the user, and a cryptocurrency wallet of the user, and the loan request message may additionally include information on the set loan cryptocurrency wallet.

According to an embodiment, to receive the loan request message from the one or more cryptocurrency exchange servers 130 or the terminal of the user, the plurality of cryptocurrency wallets in the plurality of cryptocurrency exchanges of the user may receive the loan request message from the terminal of the user in the loan system 110.

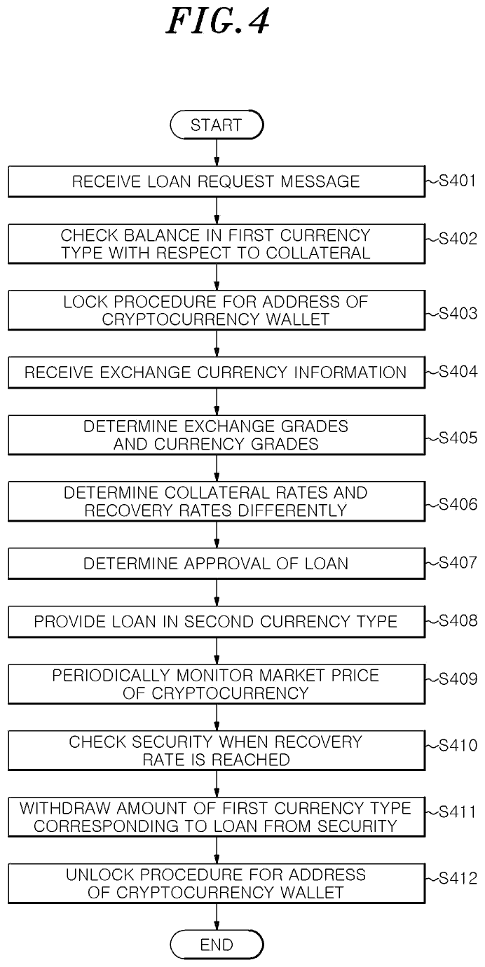

FIG. 4 is a flowchart illustrating an operating process of a loan system according to various embodiments of the present invention. Specifically, FIG. 4 illustrates an operating system including one or more loan-related servers, and each of the one or more loan-related servers includes a memory, at least one processor, and a transceiver.

Referring to FIG. 4, in an operation S401, the loan system receives a loan request message including identification information of a user, balance information about a cryptocurrency balance in at least one first currency type in one or more cryptocurrency wallets in one or more cryptocurrency exchanges of the user, a security in the first currency type, and loan information about a requested loan amount in a second currency type from the one or more cryptocurrency servers or a terminal of the user. According to an embodiment, the cryptocurrency balance is greater than or equal to the security.

In an operation S402, the loan system checks the cryptocurrency balance in the one or more cryptocurrency wallets in the one or more cryptocurrency exchanges of the user from one or more cryptocurrency exchange servers on the basis of the identification information and the balance information.

In an operation S403, the loan system performs a lock procedure for the addresses of the one or more cryptocurrency wallets.

In an operation S404, from the one or more cryptocurrency exchange servers, the loan system receives a trading volume of the at least one first currency type in the one or more cryptocurrency exchanges, a total holding of the at least one first currency type in the one or more cryptocurrency exchanges, market capitalization of the at least one first currency type, and exchange currency information about a transaction share of the at least one first currency type in the one or more cryptocurrency exchanges.

In an operation S405, the loan system determines an exchange grade for each of the one or more cryptocurrency exchanges and a currency grade for each of the at least one first currency type on the basis of the exchange currency information. According to an embodiment, the exchange grade is determined to be higher when the trading volume of the at least one first currency type in the one or more cryptocurrency exchanges, the total holding of the at least one first currency type in the one or more cryptocurrency exchanges, and the transaction share of the at least one first currency type in the one or more cryptocurrency exchanges are higher. According to an embodiment, the currency grade is determined to be higher when the trading volume of the at least one first currency type in the one or more cryptocurrency exchanges and the market capitalization of the at least one first currency type are higher.

In an operation S406, the loan system determines a collateral rate and a recovery rate differently for each of the one or more cryptocurrency exchanges on the basis of the exchange grade and the currency grade. According to an embodiment, the collateral rate is a value between 0% and 100% as a ratio of a pre-loan cash value of the requested loan amount in the second currency type to a pre-loan cash value of the security in the at least one first currency type. According to an embodiment, the recovery rate is a value between the collateral rate and 100% as a ratio of a post-loan cash value of the requested loan amount in the second currency type to a post-loan cash value of the security, which is collateral of the loan, in the at least one first currency type. According to an embodiment, the collateral rate and the recovery rate are determined to be higher when the exchange grade and the currency grade are higher.

In an operation S407, the loan system determines approval of the loan on the basis of the balance information about the one or more cryptocurrency wallets and the collateral rate in the one or more cryptocurrency exchanges of the user when a loanable amount of the second currency type is greater than or equal to the requested loan amount in the second currency type. According to an embodiment, the loanable amount is an amount of the second currency type corresponding to a cash value of a product of the security in the at least one first currency type and the collateral rate.

In an operation S408, when the approval of the loan is determined, the loan system provides the loan by transferring the requested loan amount in the second currency type from a cryptocurrency loan wallet of the loan system to a set loan cryptocurrency wallet of the user.

In an operation S409, after providing the loan, the loan system periodically monitors market prices of the first currency type and the second currency type from the one or more cryptocurrency exchange servers. Also, the loan system determines a ratio of the cash value of the requested loan amount in the second currency type to the cash value of the security in the at least one first currency type.

In an operation S410, when the ratio of the post-loan cash value of the requested loan amount in the second currency type to the post-loan cash value of the security in the at least one first currency type reaches the recovery rate, the loan system checks the security in the one or more locked cryptocurrency wallets in the one or more cryptocurrency exchanges of the user from the one or more cryptocurrency exchange servers.

In an operation S411, the loan system withdraws an amount of the at least one first currency type corresponding to the cash value of the requested loan amount in the second currency type from the security in the at least one first currency type in the one or more cryptocurrency wallets in the one or more cryptocurrency exchanges.

In an operation S412, the loan system performs an unlock procedure for the addresses of the one or more cryptocurrency wallets.

According to an embodiment, the loan system may include an application server, an approval server, and a loan server. According to an embodiment, the operation of receiving the loan request message, the operation of checking the cryptocurrency balance, and the operation of performing a lock procedure for the security in the cryptocurrency balance may be performed by the application server. According to an embodiment, the operation of receiving the exchange information, the operation of determining an exchange grade and a currency grade, the operation of determining the collateral rate and the recovery rate, and the operation of determining approval of the loan may be performed by the approval server. According to an embodiment, the operation of providing the loan may be performed by the loan server. According to an embodiment, the application server, the approval server, and the loan server may be connected to each other electrically or via a communication network.

According to an embodiment, the loan system may include a price server, a liquidation confirmation server, a liquidation withdrawal server, and an unlock server. According to an embodiment, the operation of monitoring the market prices of the first currency type and the second currency type and determining the ratio of the cash value of the requested loan amount to the cash value of the security may be performed by the price server. According to an embodiment, the operation of checking the security in the one or more locked cryptocurrency wallets in the one or more cryptocurrency exchanges of the user from the one or more cryptocurrency exchange servers may be performed by the liquidation confirmation server. According to an embodiment, the operation of withdrawing the amount of first currency corresponding to the cash value of the requested loan amount in the security from the one or more cryptocurrency wallets in the one or more cryptocurrency exchanges may be performed by the liquidation withdrawal server. According to an embodiment, the operation of performing the unlock procedure for the one or more cryptocurrency wallets may be performed by the unlock server. According to an embodiment, the price server, the liquidation confirmation server, the liquidation withdrawal server, and the unlock server may be connected to each other electrically or via a communication network.

According to an embodiment, after providing the loan, the loan system may withdraw an amount corresponding to an interest rate, which is set for an amount corresponding to the cash value of the requested loan amount in the second currency type at the time point of providing the loan, from the one or more cryptocurrency wallets in the one or more cryptocurrency exchanges of the user or the set loan cryptocurrency wallet of the user every set period of time.

According to an embodiment, when an error occurs in operations of the price server, the liquidation confirmation server, the liquidation withdrawal server, and the unlock server, the operations may be manually processed.

According to an embodiment, to perform the lock procedure for the addresses of the one or more cryptocurrency wallets, the loan system may transmit a lock request message including the identification information of the user, approval information for the loan request message, and lock request information for the addresses of the one or more cryptocurrency wallets in the one or more cryptocurrency exchanges to the one or more cryptocurrency exchange servers and receive a lock completion message including lock completion information for the addresses of the one or more cryptocurrency wallets from the one or more cryptocurrency exchange servers.

According to an embodiment, to perform the unlock procedure for the addresses of the one or more cryptocurrency wallets, the loan system may transmit a unlock request message including the identification information of the user, approval information for the loan request message, and unlock request information for the addresses of the one or more cryptocurrency wallets in the one or more cryptocurrency exchanges to the one or more cryptocurrency exchange servers and receive a unlock completion message including unlock completion information for the addresses of the one or more cryptocurrency wallets from the one or more cryptocurrency exchange servers.

According to an embodiment, the set loan cryptocurrency wallet may include at least one of a cryptocurrency wallet of the user in the one or more cryptocurrency exchange servers, a cryptocurrency custody of the user, and a cryptocurrency wallet of the user, and the loan request message may additionally include information on the set loan cryptocurrency wallet.

According to an embodiment, to receive the loan request message from the one or more cryptocurrency exchange servers or the terminal of the user, the plurality of cryptocurrency wallets in the plurality of cryptocurrency exchanges of the user may receive the loan request message from the terminal of the user in the loan system.

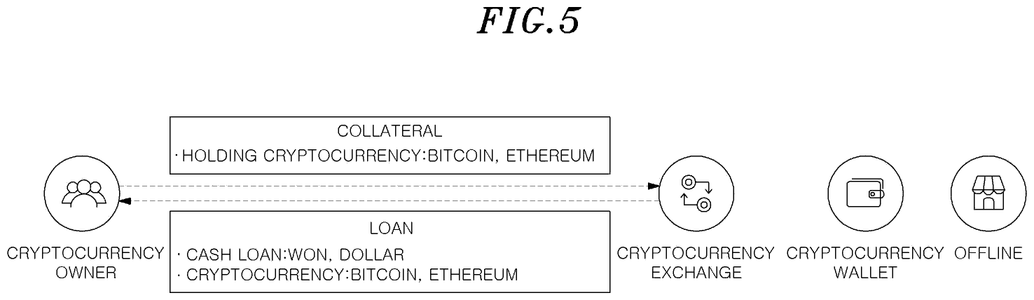

FIG. 5 illustrates an overview of a loan system according to various embodiments of the present invention.

Referring to FIG. 5, a user who possesses a cryptocurrency wallet in a cryptocurrency exchange may request a loan for an amount of a second currency type secured by an amount of a first currency type, for example, Bitcoin, Ethereum, Delio, etc., included in his or her cryptocurrency wallet. The second currency type may be identical to or different from the first currency type provided as collateral by the user. The second currency type may include at least one of cryptocurrency and cash.

When the second currency type that the user wants to borrow is cryptocurrency, the cryptocurrency exchange may request a funding server to deposit the loan into the cryptocurrency wallet of the user. Alternatively, when the second currency type that the user wants to borrow is cash, the cryptocurrency exchange may request the funding server to deposit the loan in the form of cash into an account of the user set in a financial institution.

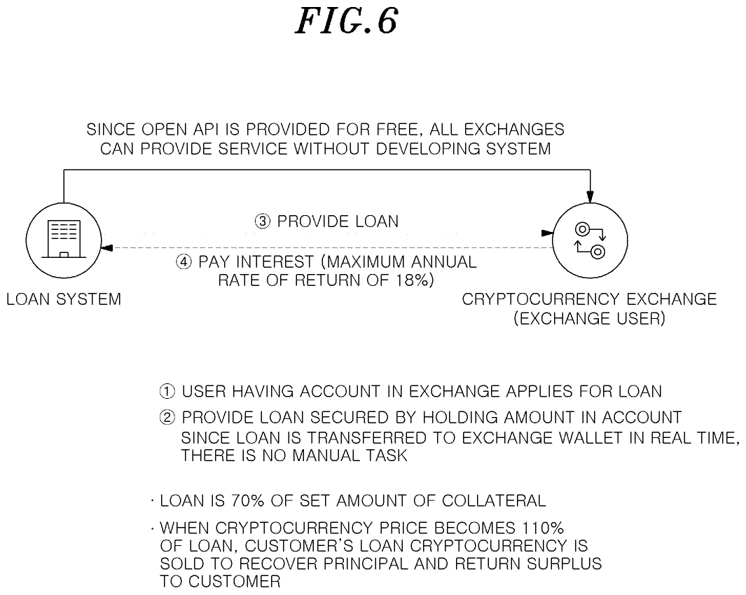

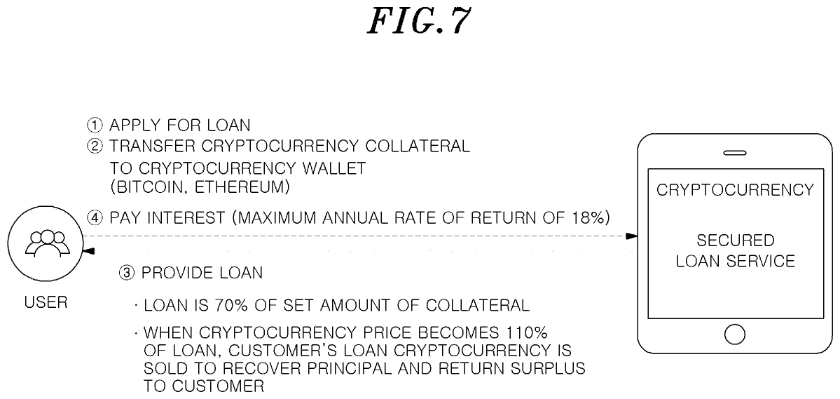

Operations performed by the system including the funding server will be described in detail below with reference to FIGS. 6 and 7.

FIG. 6 illustrates a process of a loan system according to various embodiments of the present invention. FIG. 7 illustrates a process performed by each entity in a loan system according to various embodiments of the present invention.

Referring to FIGS. 6 and 7, i) first, a user who possesses a cryptocurrency wallet generated in a cryptocurrency exchange may request a loan for an amount of a second currency type secured by his or her cryptocurrency included in the cryptocurrency wallet from the cryptocurrency exchange.

Accordingly, ii) the cryptocurrency exchange may examine whether to approve the loan for the amount of the second currency type corresponding to a certain ratio of a holding amount of cryptocurrency included in the cryptocurrency wallet of the user. In the case of approving the loan, the cryptocurrency exchange may request a funding server to pay the amount of the second currency type to the cryptocurrency wallet of the user. For example, the amount of second cryptocurrency to be loaned may be 70% of the amount of cryptocurrency set as collateral. A condition may be set to sell the cryptocurrency set as collateral, recover the principal, and return the surplus to the user when a price of the cryptocurrency set as collateral increases to 110%.

iii) When the condition is approved, the funding server may deposit an amount of the second currency type into the cryptocurrency wallet of the user or transfer the amount of the second currency type from a cryptocurrency wallet of the funding server to the cryptocurrency wallet of the user.

iv) The user pays interest (e.g., a maximum annual interest rate of 18%) on the amount of the borrowed second cryptocurrency type to the funding server or the cryptocurrency exchange at certain time intervals. Also, when a cash value of the amount of the first currency type secured by the cryptocurrency wallet of the user increases up to a certain ratio (e.g., 110%) or more of a cash value of the amount of the borrowed second cryptocurrency type, the cryptocurrency exchange or the funding server may sell the secured amount of the first currency type to recover the principal and pay the surplus to the cryptocurrency wallet of the user.

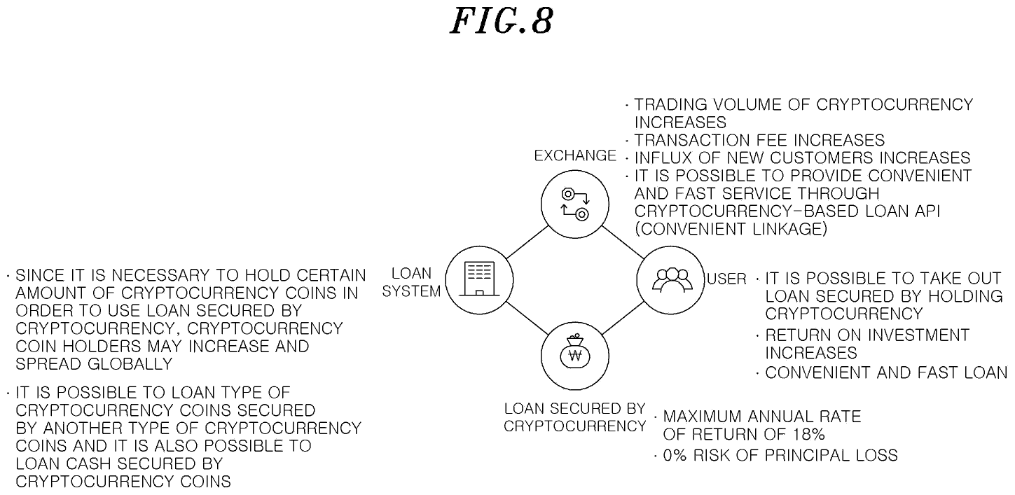

FIG. 8 illustrates effects of a loan system according to various embodiments of the present invention.

Referring to FIG. 8, a user can obtain a secured loan with his or her pre-owned cryptocurrency and obtain a convenient and fast secured loan. Also, an investor can obtain a maximum annual rate of return of 18%, and the investor's risk of principal loss can be minimized because a loan for an amount of a second currency type, which is secured by cryptocurrency included in a cryptocurrency wallet of the user and corresponds to a ratio lower than the security, is approved. A cryptocurrency exchange can benefit from an increase in cryptocurrency transaction volume, an increase in transaction fee, and an increase in the influx of new customers, and a simple and fast secured loan server is possible through application programming interface (API) linkage. The funding server benefits from an increase in the number of cryptocurrency holders because it is necessary to maintain a certain amount of cryptocurrency to provide a loan service.

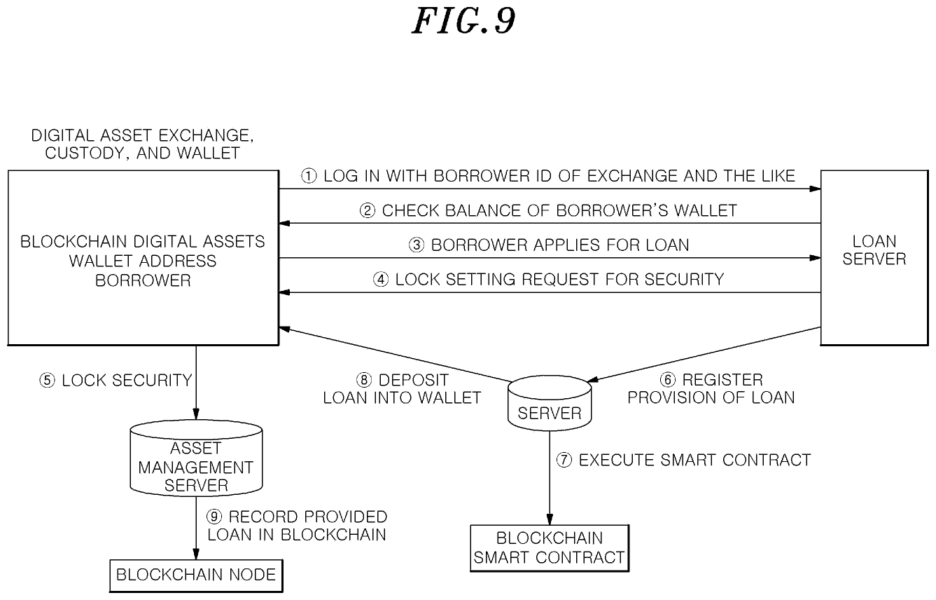

FIG. 9 illustrates a process of a loan system according to various embodiments of the present invention. Specifically, FIG. 9 illustrates a process of a remote loan system secured by digital assets.

A remote loan technology is a technology for locking the address of a blockchain digital asset wallet of a secured loan applicant or user for cryptocurrency and the like and paying a loan to the address of a wallet having collateral assets or the address of another set wallet.

Referring to FIG. 9, in step 1, a loan service user logs in from a cryptocurrency exchange, a cryptocurrency custody, or a cryptocurrency wallet to a loan server of a loan system with identification information (an identifier (ID)) of the loan service user.

In step 2, the loan server of the loan system accesses an address of the cryptocurrency wallet to check a cryptocurrency balance of the loan service user.

In step 3, the loan service user applies for a loan amount to the loan server of the loan system.

In step 4, the loan server of the loan system requests a lock setting for the address of the cryptocurrency wallet in which the security is stored.

In step 5, the lock setting request for the security is transmitted from the cryptocurrency exchange, the cryptocurrency custody, or the cryptocurrency wallet to an asset management server.

In step 6, a provided loan registration message is transmitted from the loan server of the loan system to a liquidity provider (LP) server.

In step 7, the LP server executes a smart contract of a loan contract for a blockchain smart contract server.

In step 8, the LP server deposits a loan into the cryptocurrency exchange, the cryptocurrency custody, or the cryptocurrency wallet.

In step 9, the asset management server accesses a blockchain node to record the provided loan in a blockchain.

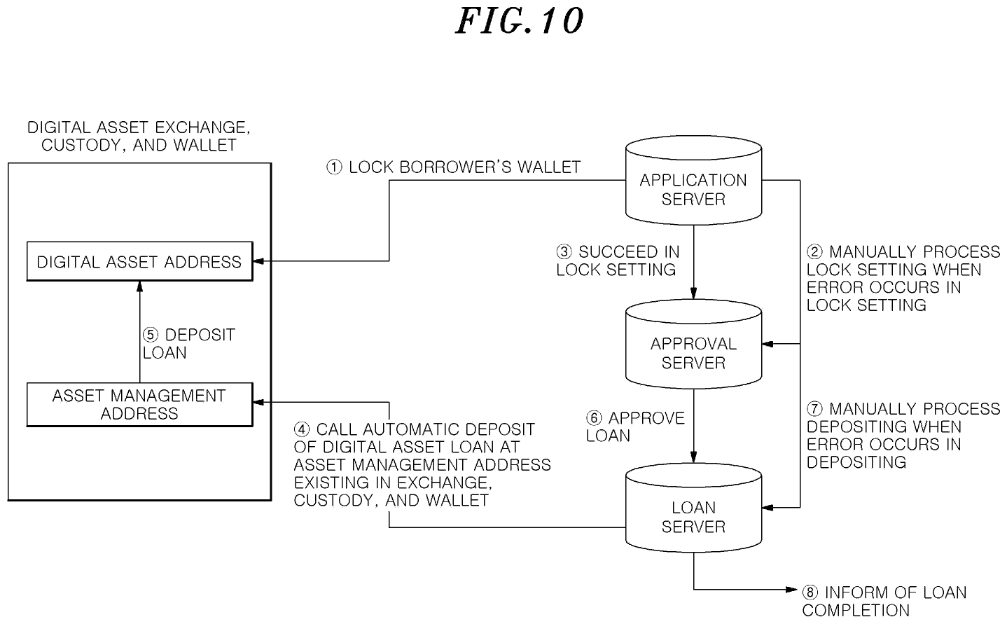

FIG. 10 illustrates a loan payment process according to various embodiments of the present invention. Specifically, FIG. 10 illustrates a loan payment process of a loan service secured by cryptocurrency.

Referring to FIG. 10, a loan system includes one or more servers including an application server, an approval server, and a loan server.

In step 1, the application server accesses a digital asset address in a cryptocurrency exchange, a cryptocurrency custody, or a cryptocurrency wallet and sets a lock for the cryptocurrency wallet of a loan service user.

When an error occurs in the lock setting of the application server, the lock setting is manually processed in step 2.

When the lock setting succeeds, the application server notifies the approval server and the loan server of the lock setting in step 3.

In step 4, the loan server calls the automatic deposit of a digital asset loan at an asset management address in the cryptocurrency exchange, the cryptocurrency custody, or the cryptocurrency wallet.

In step 5, the loan is deposited from the asset management address in the cryptocurrency exchange, the cryptocurrency custody, or the cryptocurrency wallet to a digital asset address.

In step 6, the approval server transmits a loan approval message to the loan server.

When an error occurs in transmitting the loan approval message from the approval server, the transmission of the loan approval message is manually processed in step 7.

In step 8, the loan server transmits a loan completion message.

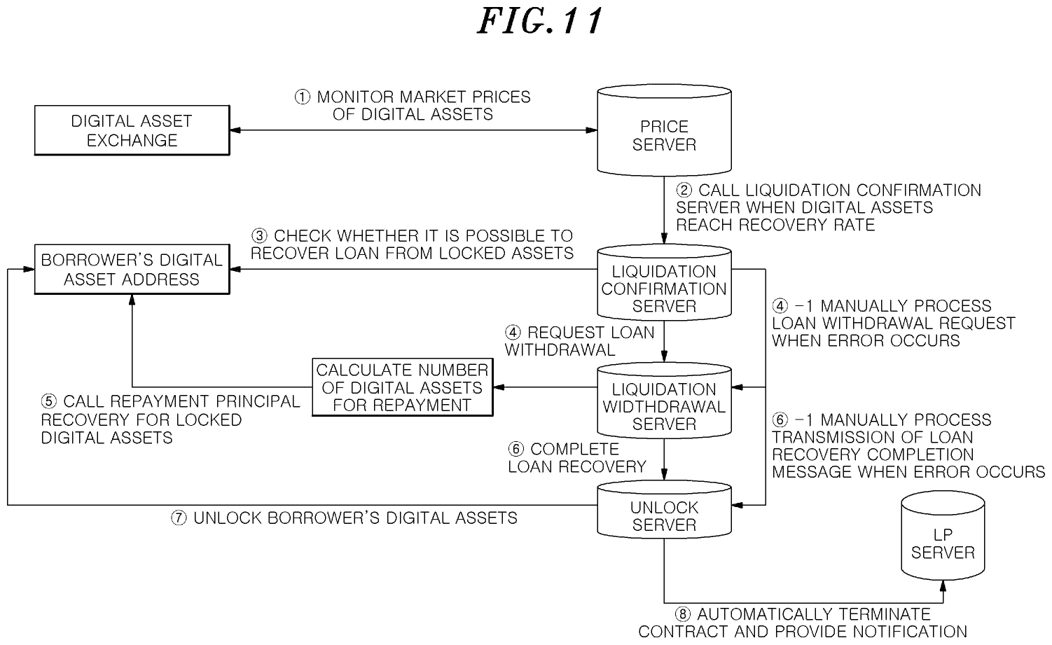

FIG. 11 illustrates a security liquidation process according to various embodiments of the present invention. Specifically, FIG. 11 illustrates an automatic liquidation process of digital assets.

In the case of cash, that is, Korean Won (KRW)-based loans, digital assets have market fluctuations, and a security should be automatically liquidated to prevent loss of the security when a set recovery rate, that is, a loan to value (LTV) ratio, is reached. A loan based on the number of digital assets has no relation with the market price because it is necessary to repay as much as the number. Liquidation-related servers of a collateral system proposed by the present invention are separated into a liquidation confirmation server, a liquidation withdrawal server, and an unlock server. Accordingly, errors occurring in a liquidation process can be checked at each step. When there is a problem in the liquidation process, it is allowed to proceed to a next step after manually resolving an error in each step. Therefore, it is possible to prevent a situation in which the entire system does not proceed due to an error.

Referring to FIG. 11, a loan system includes one or more servers including a price server, a liquidation confirmation server, a liquidation withdrawal server, an unlock server, and an LP server.

In step 1, the price server accesses a digital asset exchange to monitor the market price of digital assets.

In step 2, when the digital assets reach a determined recovery rate, the price server calls the liquidation confirmation server.

In step 3, the liquidation confirmation server accesses a digital asset address of a borrower to check whether it is possible to recover a loan from locked assets.

In step 4, after checking that it is possible to recover the loan, the liquidation confirmation server transmits a loan withdrawal request message to the liquidation withdrawal server.

When an error occurs in transmission of the loan withdrawal request message from the liquidation confirmation server, the loan withdrawal request message is manually transmitted to the liquidation withdrawal server in step 4-1.

In step 5, the liquidation withdrawal server calculates the number of digital assets for repayment and transmits a repayment principal recovery call message for the locked digital assets to the digital asset address of the borrower.

In step 6, after recovering the loan, the liquidation withdrawal server transmits a loan recovery completion message to the unlock server.

When an error occurs in transmission of the loan recovery completion message from the liquidation withdrawal server, the loan recovery completion message is manually transmitted to the unlock server in step 6-1.

In step 7, the unlock server transmits an unlock message for the digital asset address of the borrower to the digital asset address of the borrower.

In step 8, the unlock server transmits an automatic contract termination notification message that informs about termination of the loan contract to the LP server.

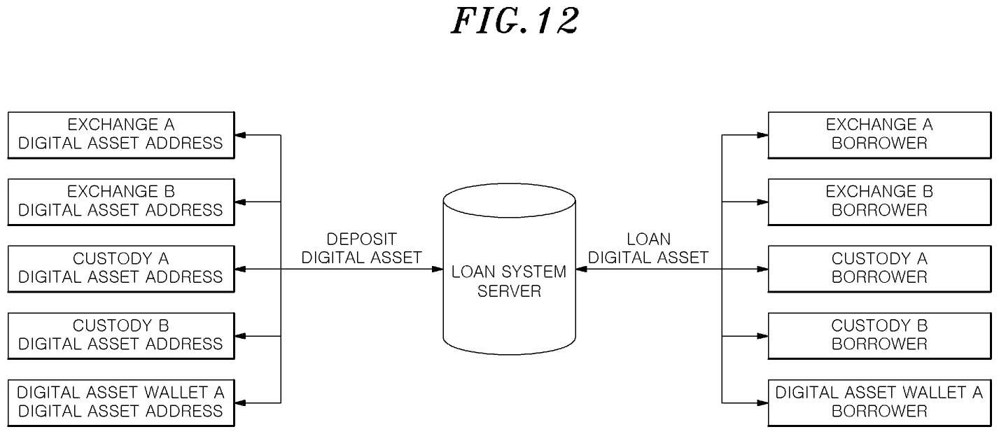

FIG. 12 illustrates an overview of a loan system secured by assets of a plurality of cryptocurrency wallets in a plurality of cryptocurrency exchanges according to various embodiments of the present invention. Specifically, FIG. 12 illustrates a loan system employing a virtual liquidity server employing a plurality of cryptocurrency wallets in a plurality of cryptocurrency exchanges.

Referring to FIG. 12, calculation of cryptocurrency holdings scattered across a plurality of cryptocurrency wallets in a plurality of cryptocurrency exchanges of one user is allowed such that the corresponding loan amount secured by the cryptocurrency can be increased. Also, in terms of a loan system, it is possible to provide liquidity to a plurality of exchanges rather than one exchange, and thus cooperative relationships with a plurality of exchanges can be established. Further, convenience of users who use a plurality of exchanges can be maximized. In general, users who do many cryptocurrency transactions use a plurality of cryptocurrency exchanges. Therefore, liquidity provision can be increased through a virtualization technology for recognizing digital asset addresses scattered across a plurality of cryptocurrency exchanges as one address. Accordingly, a total amount of liquidity that can be used by the loan system of the present invention is a total sum of cryptocurrency balances of a plurality of cryptocurrency exchanges, cryptocurrency custodies, and cryptocurrency wallets.

According to an additional embodiment, the loan system of the present invention may determine a cryptocurrency exchange grade. A loanable amount of cryptocurrency may be determined using the grade of each cryptocurrency exchange as a weight. The loan system that provides a loan secured by cryptocurrency should maintain cooperative relationships with reliable cryptocurrency exchanges to make users of the loan system actively use a cryptocurrency loan service. Past transaction data of a specific cryptocurrency exchange may be retrieved, and a grade system may be created for cryptocurrency exchanges on the basis of past transaction data. For example, a grade system for cryptocurrency exchanges may be created by considering the cryptocurrency exchanges' trading volumes, capital, total cryptocurrency holdings, whether hot wallets or cold wallets are used, etc. A reliability grade of each cryptocurrency exchange may be determined on the basis of the above considerations. Even when the same type of cryptocurrency is used as collateral, a larger amount of secured loan may be provided for the cryptocurrency kept in a cryptocurrency wallet of a cryptocurrency exchange with a higher reliability grade.

According to an additional embodiment, the loan system of the present invention may determine a currency grade of cryptocurrency. A loanable amount of cryptocurrency may be determined using the currency grade of each cryptocurrency as a weight. The loan system that provides a loan secured by cryptocurrency should maintain more loans based on reliable cryptocurrency to make users of the loan system actively use a cryptocurrency loan service. Transaction data of each cryptocurrency type may be retrieved to create a currency grade system for cryptocurrency types. For example, a currency grade system for cryptocurrency types may be created by considering a trading volume of a corresponding cryptocurrency type, the market capitalization of the corresponding currency type, etc. A currency grade of each cryptocurrency type may be determined on the basis of the above considerations. Even when the same value of cryptocurrency is used as collateral, a higher cash value secured loan may be provided for a cryptocurrency type with a higher currency grade.

For example, a loan may be secured by cryptocurrency of currency type B-1 corresponding to a cash value of 10,000,000 won kept in exchange A-1, and a loan may be secured by cryptocurrency of currency type B-2 corresponding to a cash value 10,000,000 won kept in exchange A-2. Here, exchange A-1 may have a higher exchange grade than exchange A-2, and currency type B-1 may have a higher currency grade than currency type B-2.

In this case, according to various embodiments of the present invention, when a loan is provided using the cryptocurrency of currency type B-1 corresponding to a cash value of 10,000,000 won kept in exchange A-1 as collateral, a collateral rate and a recovery rate may be determined to be 70% and 85%, respectively. In other words, a loan corresponding to a cash value of 7,000,000 won may be provided, and when the cryptocurrency price of the currency type B-1, which is a security, is changed to 8,500,000 won thereafter, the security may be liquidated, and the loan may be recovered.

Also, when a loan is provided using the cryptocurrency of currency type B-2 corresponding to a cash value of 10,000,000 won kept in exchange A-2 as collateral, a collateral rate and a recovery rate may be determined to be 60% and 75%, respectively. In other words, due to the lower exchange grade and the lower currency grade, the collateral rate and the recovery rate may be lower than those of the case in which a loan is provided using the cryptocurrency of currency type B-1 corresponding to a cash value of 10,000,000 won kept in exchange A-1 as collateral. Accordingly, a loan corresponding to a cash value of 6,000,000 won may be provided, and when the cryptocurrency price of the currency type B-2, which is a security, is changed to 7,500,000 won thereafter, the security may be liquidated, and the loan may be recovered.

When an embodiment of the present invention is implemented with hardware, application-specific integrated circuits (ASICs) configured to perform the present invention, or digital signal processors (DSPs), digital signal processing devices (DSPDs), programmable logic devices (PLDs), field programmable gate arrays (FPGAs), etc. may be provided in a processor of the present invention.

Meanwhile, the above-described method can be written as a computer-executable program and can be implemented in a general-use digital computer that executes the program using a computer-readable medium. Also, the structure of data used in the above-described method may be recorded on a computer-readable storage medium through various means. Program storage devices that may be used for describing a storage device including executable computer code for performing various methods of the present invention should not be construed as including transitory objects such as carrier waves or signals. The computer-readable storage medium includes a storage medium such as a magnetic storage medium (e.g., a read only memory (ROM), a floppy disk, a hard disk, etc.) and an optical medium (e.g., a compact disc read only memory (CD-ROM), a digital versatile disc (DVD), etc.).

In the embodiments described above, components and features of the present invention are combined in a certain form. Each component or feature should be considered to be optional unless explicitly stated otherwise. Each component or feature may be implemented in a form that is not combined with other components or features. Also, it is possible to configure an embodiment of the present invention by combining some components and/or features. The order of operations described in the embodiments of the invention may be changed. Some configurations or features of an embodiment may be included in other embodiments or replaced with corresponding configurations or features of other embodiments. It is obvious that claims that are not explicitly cited in the claims can be combined into an embodiment or included as a new claim by amendment after filing.

It will be apparent to those of ordinary skill in the art that the present invention can be embodied in other forms without departing from the technical spirit and essential features of the present invention. Accordingly, the above embodiments should be considered in all aspects as illustrative and not restrictive. The scope of the present invention should be determined by a reasonable interpretation of the appended claims and all possible changes within the equivalent scope of the present invention.

### INDUSTRIAL APPLICABILITY

The present invention relates to a method and device for processing a loan secured by digital assets such as cryptocurrency. Specifically, the present invention relates to a method and device for processing a loan in a second currency type using an amount of a first currency type kept in a cryptocurrency wallet and the like in a cryptocurrency exchange as collateral.

What is claimed is:

1. A method of operating a loan system including one or more loan-related servers, each of which includes a memory, at least one processor, and a transceiver, the method comprising:
receiving, from one or more cryptocurrency exchange servers or a terminal of a user, a loan request message including identification information of the user, balance information about a cryptocurrency balance in at least one first currency type in one or more cryptocurrency wallets in one or more cryptocurrency exchanges of the user, a security, which is smaller than or equal to the cryptocurrency balance, in the first currency type, and loan information about a requested loan amount in a second currency type;
checking the cryptocurrency balance in the one or more cryptocurrency wallets in the one or more cryptocurrency exchanges of the user from the one or more cryptocurrency exchange servers on the basis of the identification information and the balance information;
performing a lock procedure for addresses of the one or more cryptocurrency wallets;
receiving, from the one or more cryptocurrency exchange servers, a trading volume of the at least one first currency type in the one or more cryptocurrency exchanges, a total holding of the at least one first currency type in the one or more cryptocurrency exchanges, market capitalization of the at least one first currency type, and exchange currency information about a transaction share of the at least one first currency type in the one or more cryptocurrency exchanges;
determining an exchange grade for each of the one or more cryptocurrency exchanges and a currency grade for each of the at least one first currency type on the basis of the exchange currency information, wherein the exchange grade is determined to be higher when the trading volume of the at least one first currency type in the one or more cryptocurrency exchanges, the total holding of the at least one first currency type in the one or more cryptocurrency exchanges, and the transaction share of the at least one first currency type in the one or more cryptocurrency exchanges are higher, and the currency grade is determined to be higher when the trading volume of the at least one first currency type in the one or more cryptocurrency exchanges and the market capitalization of the at least one first currency type are higher;
determining a collateral rate and a recovery rate differently for each of the one or more cryptocurrency exchanges on the basis of the exchange grade and the currency grade wherein the collateral rate is a value between 0% and 100% as a ratio of a pre-loan cash value of the requested loan amount in the second currency type to a pre-loan cash value of the security in the at least one first currency type, the recovery rate is a value between the collateral rate and 100% as a ratio of a post-loan cash value of the requested loan amount in the second currency type to a post-loan cash value of the security, which is collateral of the loan, in the at least one first currency type, and the collateral rate and the recovery rate are determined to be higher when the exchange grade and the currency grade are higher;
determining approval of the loan on the basis of the balance information about the one or more cryptocurrency wallets and the collateral rate in the one or more cryptocurrency exchanges of the user when a loanable amount of the second currency type is greater than or equal to the requested loan amount in the second currency type wherein the loanable amount is an amount of the second currency type corresponding to a cash value of a product of the security in the at least one first currency type and the collateral rate;
when the approval of the loan is determined, transferring the requested loan amount in the second currency type from a cryptocurrency loan wallet of the loan system to a set loan cryptocurrency wallet of the user to provide the loan;
periodically monitoring market prices of the first currency type and the second currency type from the one or more cryptocurrency exchange servers after providing the loan, and determining a ratio of the cash value of the requested loan amount in the second currency type to the cash value of the security in the at least one first currency type;
when the ratio of the post-loan cash value of the requested loan amount in the second currency type to the post-loan cash value of the security in the at least one first currency type reaches the recovery rate, checking the security in the one or more locked cryptocurrency wallets in the one or more cryptocurrency exchanges of the user from the one or more cryptocurrency exchange servers;
withdrawing an amount of the at least one first currency type corresponding to the cash value of the requested loan amount in the second currency type from the security in the at least one first currency type in the one or more cryptocurrency wallets in the one or more cryptocurrency exchanges; and
performing an unlock procedure for the addresses of the one or more cryptocurrency wallets.

2. The method of claim 1,
wherein the loan system comprises an application server, an approval server, and a loan server,
the receiving of the loan request message, the checking of the cryptocurrency balance, and the performing of the lock procedure for the security are performed by the application server,
the receiving of the exchange information, the determining of the exchange grade and the currency grade, the determining of the collateral rate and the recovery rate, and the determining of the approval of the loan are performed by the approval server,
the providing of the loan is performed by the loan server, and
the application server, the approval server, and the loan server are connected to each other.

3. The method of claim 1,
wherein the loan system comprises a price server, a liquidation confirmation server, a liquidation withdrawal server, and an unlock server,
the monitoring of the market prices of the first currency type and the second currency type and the determining of the ratio of the cash value of the requested loan amount to the cash value of the security are performed by the price server,
the checking of the security in the one or more locked cryptocurrency wallets in the one or more cryptocurrency exchanges of the user from the one or more cryptocurrency exchange servers is performed by the liquidation confirmation server,
the withdrawing of the amount of first currency corresponding to the cash value of the requested loan amount from the security in the one or more cryptocurrency wallets in the one or more cryptocurrency exchanges is performed by the liquidation withdrawal server,
the performing of the unlock procedure for the one or more cryptocurrency wallets is performed by the unlock server, and
the price server, the liquidation confirmation server, the liquidation withdrawal server, and the unlock server are connected to each other.

4. The method of claim 1,
further comprising, after the providing of the loan, withdrawing an amount corresponding to interest of an interest rate, which is set for an amount corresponding to the cash value of the requested loan amount in the second currency type at a time point of providing the loan, from the one or more cryptocurrency wallets in the one or more cryptocurrency exchanges of the user or the set loan cryptocurrency wallet of the user every set period of time.

5. The method of claim 3,
wherein, when an error occurs in operations of the price server, the liquidation confirmation server, the liquidation withdrawal server, and the unlock server, the operations are manually processed.

6. The method of claim 1,
wherein the performing of the lock procedure for the addresses of the one or more cryptocurrency wallets comprises:
transmitting a lock request message including the identification information of the user, approval information for the loan request message, and lock request information for the addresses of the one or more cryptocurrency wallets in the one or more cryptocurrency exchanges to the one or more cryptocurrency exchange servers; and
receiving a lock completion message including lock completion information for the addresses of the one or more cryptocurrency wallets from the one or more cryptocurrency exchange servers.

7. The method of claim 1,
wherein the set loan cryptocurrency wallet includes at least one of a cryptocurrency wallet of the user in the one or more cryptocurrency exchange servers, a cryptocurrency custody of the user, and a cryptocurrency wallet of the user, and
the loan request message additionally includes information on the set loan cryptocurrency wallet.

8. The method of claim 1,
wherein the receiving of the loan request message from the one or more cryptocurrency exchange servers or the terminal of the user comprises receiving, by the plurality of cryptocurrency wallets in the plurality of cryptocurrency exchanges of the user, the loan request message from the terminal of the user.

9. A loan system including one or more loan-related servers, wherein each of the one or more loan-related servers comprises a memory, at least one processor, and a transceiver, and
the at least one processor of each of the one or more loan-related servers is configured to perform the method of claim 1.

10. A computer program configured to perform the method of claim 1 and recorded on a computer-readable recording medium.
